(19) United States
(12) Patent Application Publication
(10) Pub. No.: US 2011/0107402 A1
(43) Pub. Date: May 5, 2011

(54) CLIENT SERVER SYSTEM, CLIENT APPARATUS AND SERVER APPARATUS DISPLAYING CONTENTS OF PROVIDED SERVICES

(76) Inventor: Yoshinori NAGATA, Osaka (JP)

(21) Appl. No.: 12/908,976

(22) Filed: Oct. 21, 2010

(30) Foreign Application Priority Data
Oct. 29, 2009 (JP) 2009-248825

(51) Int. Cl. G06F 21/00; G06F 15/16

(52) U.S. Cl. 726/4; 709/203

(57) ABSTRACT

A client server system allowing easy selection of a provided service is provided. In the client server system, a server apparatus includes: an HDD storing a service ID and a user ID indicating a user who is logged in to the service in association with each other; a control unit searching for a service logged in by the user who is logged in to the MFP based on the information stored in the HDD, in response to an inquiry from MFP; and an LAN I/F transmitting the result of search by the control unit to the MFP. The MFP is adapted to include: an operation panel; an inquiry function of a control unit for inquiring of the server about the logged-in service; an LAN I/F receiving the result of search; and a display control function of the control unit, causing the operation panel to display an image indicating the logged-in service, based on the received result of search.

### CROSS-REFERENCE TO RELATED APPLICATION

This nonprovisional application claims priority under 35 U.S.C. §119(a) on Patent Application No. 2009-248825 filed in Japan on Oct. 29, 2009, the entire contents of which are hereby incorporated by reference.

### BACKGROUND OF THE INVENTION

1. Field of the Invention

The present invention relates to a client server system, client apparatus and server apparatus and, more specifically, to a technique of displaying contents of provided services.

2. Description of the Background Art

A client server system in which a server apparatus and a client apparatus that use various services provided by the server apparatus are connected to each other through a network has been widely used.

By way of example, Japanese Patent Laying-Open No. 2006-74345 (hereinafter referred to as “'345 Reference”) discloses a data transmission apparatus connected through a network to a transmission destination searching server that stores and searches pieces of transmission destination information. At the time of user log-in, the data transmission apparatus causes the transmission destination searching server to automatically search for pieces of transmission destination information that will be highly likely used by the user, receives and stores the results of search, whereby the pieces of transmission destination information are updated.

Further, a technique of displaying a list of various services provided by a server apparatus on an operation panel of a digital multifunction peripheral as a client apparatus has been known. A user, viewing the displayed list, can select and use a desired service through an input operation of the operation panel.

According to the technique disclosed in '345 Reference, it is necessary to prepare pieces of user information including transmission destinations and specific users associated with each other and, therefore, initialization of the user information requires time and labor. Further, if the number of transmission destinations associated with a specific user is large, it takes time for the user to select a transmission destination.

According to the technique of displaying a list of various services, if the number of services provided by the server apparatus is large, it takes time for the user to select a service.

### SUMMARY OF THE INVENTION

An object of the present invention is to provide a client server system, client apparatus and server apparatus that allow easy selection of a service to be provided.

According to an aspect, the present invention provides a client server system, including a server apparatus providing at least one service, and a client apparatus performing data communication with the server apparatus through a network. The server apparatus includes: a storage unit storing service information indicating the service and user information indicating a user who is logged in to the service, in association with each other; a searching unit, searching for a service to which a user using the client apparatus is logged in, in response to an inquiry from the client apparatus, based on the information stored in the storage unit; and a transmitting unit, transmitting the result of search by the searching unit to the client apparatus. The client apparatus includes: a display device; an inquiry unit inquiring of the server apparatus about a service to which the user using the client apparatus is logged in; a receiving unit receiving the result of search; and a display control unit causing the display device to display an image indicating the service to which the user using the client apparatus is logged in, based on the received result of search.

An image indicating a service to which the user using the client apparatus is logged in among the at least one service provided by the server apparatus is displayed. The user can easily select a desired service. Since the service information and the user information are stored automatically, the time and labor for preparing these pieces of information can be saved. Thus, it is convenient for the user.

Preferably, the storage unit stores log-in date and time information indicating the time of log-in to the service, in association with the service information and the user information. The transmitting unit transmits the result of search and the log-in date and time information to the client apparatus. The display control unit causes the display device to display an image showing services logged in by the user who is using the client apparatus sorted in the order of date and time of log-in, based on the received result of search and the log-in date and time information.

It is possible for the user to confirm the order of log-in to the displayed services at a glance. By way of example, the user can easily select a service to which the user logged in recently. Therefore, it is possible for the user to more easily select a desired service, which is more convenient for the user.

More preferably, the storage unit stores last access date and time information indicating the time when last access was done among accesses to the service while the user was logged in, in association with the service information and the user information. The transmitting unit transmits the result of search and the last access date and time information to the client apparatus. The display control unit causes the display device to display an image showing services logged in by the user who is using the client apparatus sorted in the order of date and time of last access, based on the received result of search and the last access date and time information.

It is possible for the user to confirm the order of last accesses to the displayed services at a glance. By way of example, the user can easily select a service that he/she used recently. Therefore, it is possible for the user to more easily select a desired service, which is more convenient for the user.

More preferably, the storage unit stores log-in number information indicating the number of times of log-in by the user, in association with the service information and the user information. The transmitting unit transmits the result of search and the log-in number information to the client apparatus. The display control unit causes the display device to display an image showing services logged in by the user who is using the client apparatus sorted in the order of the number of times of log-in, based on the received result of search and the log-in number information.

It is possible for the user to confirm whether the number of times of log-in to a displayed service is large or small at a glance. By way of example, the user can easily select a service that is most frequently used. Therefore, it is possible for the user to more easily select a desired service, which is more convenient for the user.

More preferably, the client apparatus further includes a limiting information storage unit storing limiting information for limiting a service or services usable by the client apparatus. The display control unit causes the display device to display an image showing the service or services limited by the limiting information, among services logged in by the user who is using the client apparatus, based on the received result of search and the limiting information. Therefore, only the services usable from the client apparatus are displayed among the services to which the user using the client apparatus logged in. Thus, convenience for the user can further be improved.

More preferably, the limiting information storage unit stores, as the limiting information, user information indicating a user, a service or services usable by the user, and the server apparatus or server apparatuses usable by the user, in association with each other. Use of apparatuses and services can be limited user by user and, therefore, the services that are usable by the client apparatus can more easily be limited.

More preferably, the client apparatus further includes a service selecting unit allowing the user to select any of the services. The display control unit causes the display device to display an image showing the service selected by the service selecting unit, among services logged in by the user who is using the client apparatus, based on the received result of search. Since an image showing the service selected by the user among the services to which the user using the client apparatus logged in is displayed, convenience for the user can further be improved.

More preferably, the client apparatus further includes a mode selecting unit allowing the user to select any of a plurality of operation modes. The service selecting unit allows the user to select any of services in accordance with the operation mode selected by the mode selecting unit. Accordingly, it becomes possible for the user to select a service in accordance with the operation mode. Thus, convenience for the user can further be improved.

More preferably, the client apparatus further includes a receiving unit receiving a service determined by the user as a service to be used, from the services indicated by the image, and a using unit using the service received by the receiving unit. Accordingly, it becomes possible for the user to easily use the desired service. Thus, convenience for the user can further be improved.

More preferably, the server apparatus further includes a first authentication unit determining whether or not a user is an authorized user, and permitting log-in by the user to the service if the user is an authorized user. The client apparatus further includes a second authentication unit determining whether or not a user is an authorized user, and permitting log-in by the user to the client apparatus if the user is an authorized user.

Since the first and second authentication units are provided, it is possible to prevent a third party not permitted to use at least the service or the client apparatus from abusing the service.

More preferably, the server apparatus is a personal computer, and the client apparatus is an image forming apparatus. Alternatively, the server apparatus is an image forming apparatus and the client apparatus is a personal computer. Accordingly, convenience of the image forming apparatus and the personal computer can further be improved.

According to another aspect, the present invention provides a client apparatus performing data communication through a network with a server apparatus providing at least one service, including: a display apparatus; an inquiry unit inquiring of the server apparatus about a service to which the user using the client apparatus is logged in, a receiving unit receiving result of search obtained from the server apparatus by a search for the service to which the user using the client apparatus is logged in, based on information storing service information indicating the service and user information indicating a user logged in to the service in association with each other, in response to the inquiry; and a display control unit causing the display device to display an image indicating the service to which the user using the client apparatus is logged in, based on the received result of search.

According to a still another aspect, the present invention provides a server apparatus providing at least one service and performing data communication through a network with a client apparatus, including: a storage unit storing service information indicating the service and user information indicating a user who is logged in to the service, in association with each other; a searching unit, searching for a service to which a user using the client apparatus is logged in, in response to an inquiry from the client apparatus, based on the information stored in the storage unit; and a transmitting unit, transmitting the result of search by the searching unit to the client apparatus.

The image showing the service to which the user using the client apparatus is logged in among at least one service provided by the server apparatus is displayed. The user can easily select a desired service. Further, since the service information and the user information are automatically stored, the time and labor for preparing these pieces of information can be saved. Thus, convenience for the user can further be improved.

According to the present invention, in the client server system, an image showing the service to which the user using the client apparatus is logged in among at least one service provided by the server apparatus is displayed. The user can easily select a desired service. Since the service information and the user information are automatically stored, the time and labor for preparing these pieces of information can be saved. Thus, convenience for the user can further be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing a configuration of a client server system in accordance with a first embodiment of the present invention.

FIG. 2 is a block diagram showing a configuration of the server apparatus.

FIG. 3 shows an exemplary data configuration of log-in history data.

FIG. 4 is a block diagram showing a configuration of an MFP.

FIG. 5 is a block diagram showing a configuration of a PC.

FIG. 6 is a flowchart representing a program structure for realizing the service list display process in accordance with a first embodiment of the present invention.

FIG. 7 shows an exemplary image based on a sorted service list data.

FIG. 8 is a flowchart representing a program structure for realizing the service list display process in accordance with a first modification of the first embodiment of the present invention.

FIG. 9 is a flowchart representing a program structure for realizing the service list display process in accordance with a second modification of the first embodiment of the present invention.

FIG. 10 is a flowchart representing a program structure for realizing the service list display process in accordance with a third modification of the first embodiment of the present invention.

FIG. 11 is a block diagram schematically showing a configuration of the client server system in accordance with a second embodiment of the present invention.

FIG. 12 illustrates a file management service provided by the PC.

FIG. 13 is a flowchart representing a program structure for realizing a scan transmission destination display process in accordance with a second embodiment of the present invention.

FIG. 14 shows an exemplary image based on a scan transmission destination list data.

FIG. 15 is a flowchart representing a program structure for realizing an address book saving destination display process in accordance with a first modification of the second embodiment of the present invention.

FIG. 16 is a flowchart representing a program structure for realizing a print data saving destination display process in accordance with a second modification of the second embodiment of the present invention.

FIG. 17 is a block diagram schematically showing a configuration of another modification of the client server system.

FIGS. 18 and 19 show examples of selection images.

### DESCRIPTION OF THE PREFERRED EMBODIMENTS

In the following description and in the drawings, the same components are denoted by the same reference characters and same names. Their functions are also the same. Therefore, detailed description thereof will not be repeated.

### First Embodiment

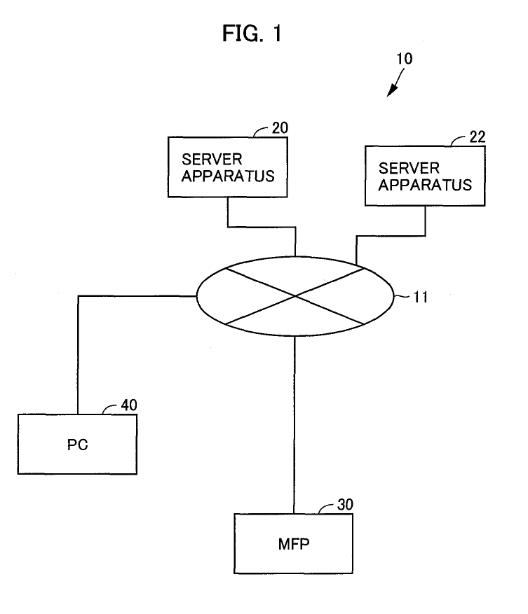

Referring to FIG. 1, a client server system 10 includes server apparatuses 20 and 22, a digital multifunction peripheral (hereinafter referred to as an MFP) 30, and a PC (Personal Computer) 40. Server apparatuses 20 and 22, MFP 30 and PC 40 are connected to each other through a network 11 implemented, for example, by LAN (Local Area Network) line, and capable of data communication with each other.

Server apparatuses 20 and 22 provide various services to users using MFP 30 and PC 40. Though not limiting, the services include, for example, a document management service, a schedule management service, an address book management service, an electronic conference service and a remote PC service.

PC 40 represents a terminal operated by a user who is to use various functions of MFP 30 and various services provided by server apparatuses 20 and 22. By way of example, when a user issues a print instruction from PC 40 to MFP 30, MFP 30 executes a print process based on image data as an object of printing. When the user logs in to a service provided by server apparatus 20 or 22, server apparatus 20 or 22 comes to be able to provide the logged-in service to the user.

The numbers of server apparatuses 20 and 22, MFP 30 and PC 40 are not limited to those shown in FIG. 1. For instance, only one server apparatus 20 or 22 may be provided, or three or more servers may be provided. Further, client server system 10 may include other peripherals in addition to the apparatuses described above.

<Hardware Configuration>

[Server Apparatus 20, 22]

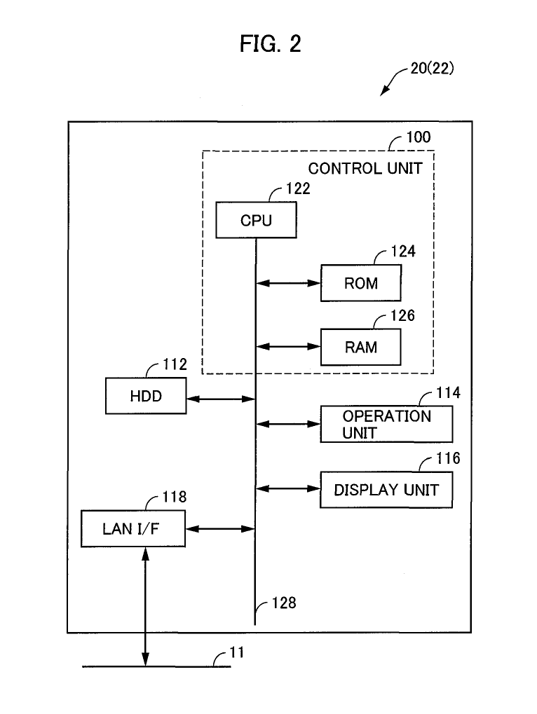

Referring to FIG. 2, server apparatuses 20 and 22 have the same configuration. Server apparatus 20 (22) is implemented, for example, by a PC server, and it includes a control unit 100, an HDD (Hard Disk Drive) 112, an operation unit 114, a display unit 116, and an LAN I/F 118.

Control unit 100 is substantially a computer, and it includes a CPU (Central Processing Unit) 122, an ROM (Read Only Memory) 124 and an RAM (Random Access Memory) 126. To CPU 122, a bus line 128 is connected, and to bus line 128, ROM 124 and RAM 126 are electrically connected. CPU 122 executes various computer programs (hereinafter also simply referred to as “programs”) in accordance with instructions from operation unit 114 or from external apparatus such as MFP 30 and PC 40, and thereby executes operations of various components of server apparatus 20 (22) and desired processes such as communication with an external apparatus.

Various computer programs mentioned above are stored in advance in ROM 124 or HDD 112 and, when a desired process is to be executed, read from ROM 124 or HDD 112 and transferred to RAM 126. CPU 122 reads a program instruction from an address in RAM 126 designated by a value stored in a register referred to as a program counter, not shown, in CPU 122, and interprets the same. Further, CPU 122 reads data necessary for operation from an address designated by the read instruction, and executes an operation corresponding to the instruction on the data. The result of execution is also stored in the address designated by the instruction, in RAM 126, HDD 112 or a register in CPU 122.

To bus line 128, HDD 112, operation unit 114, display unit 116 and LAN I/F 118 are electrically connected.

HDD 112 stores, together with a program for realizing general operations of server apparatus 20 (22), various data including log-in history data. The log-in history data represents pieces of information showing history of services used by the user, among various services provided by server apparatus 20 (22).

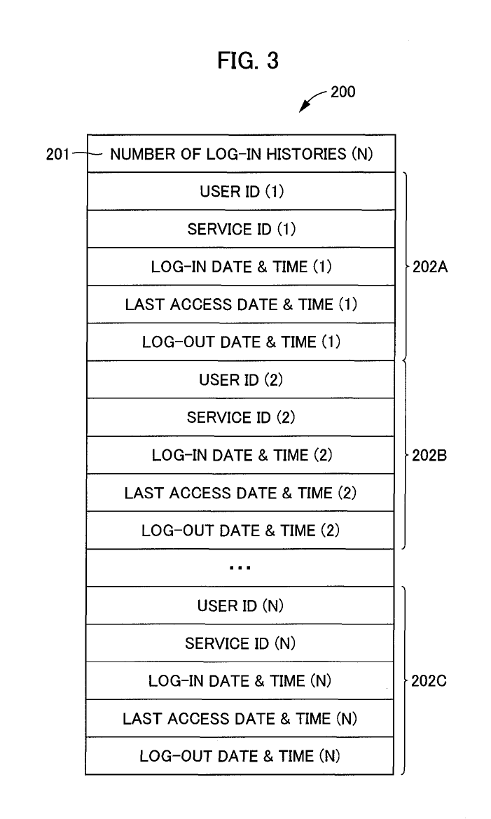

Referring to FIG. 3, log-in history data 200 includes a piece of information 201 indicating the total number N of the pieces of log-in history information, and the first to N-th pieces of log-in history information 202A to 202C. Each of the pieces of log-in history information 202A to 202C includes: a user ID (Identification) for distinguishing and identifying a user; a service ID for distinguishing and identifying a provided service; a piece of information indicating date and time of log-in as a time when the user started using the service; a piece of information indicating date and time of last access as a time when last access was made, of the accesses made to the service while the user was logged in; and a piece of information indicating date and time of log-out as a time when the user ended use of the service. Log-in history information 202 is additionally stored every time the user starts using a service, that is, every time the user logs in to a service. The piece of information indicating the date and time of log-in, the piece of information indicating the date and time of last access, and the piece of information indicating the date and time of log-out are written based on current time obtained by a timer function of server apparatus 20 (22).

Operation unit 114 includes a keyboard used for various inputs and character inputs in accordance with, for example, a user instruction, and a mouse as a pointing device. Display unit 116 is a display device implemented, for example, by a liquid crystal display, for displaying processed results and the like of server apparatus 20 (22). Operation unit 114 and display unit 116 are connected through an interface (not shown) to bus line 128.

Server apparatus 20 (22) is connected to network 11 through LAN I/F 118, and it is capable of data communication with an external apparatus connected to network 11.

A power source (not shown) is connected to various components of server apparatus 20 (22), and a voltage applied from the power source enables operations of various components of server apparatus 20 (22).

[MFP 30]

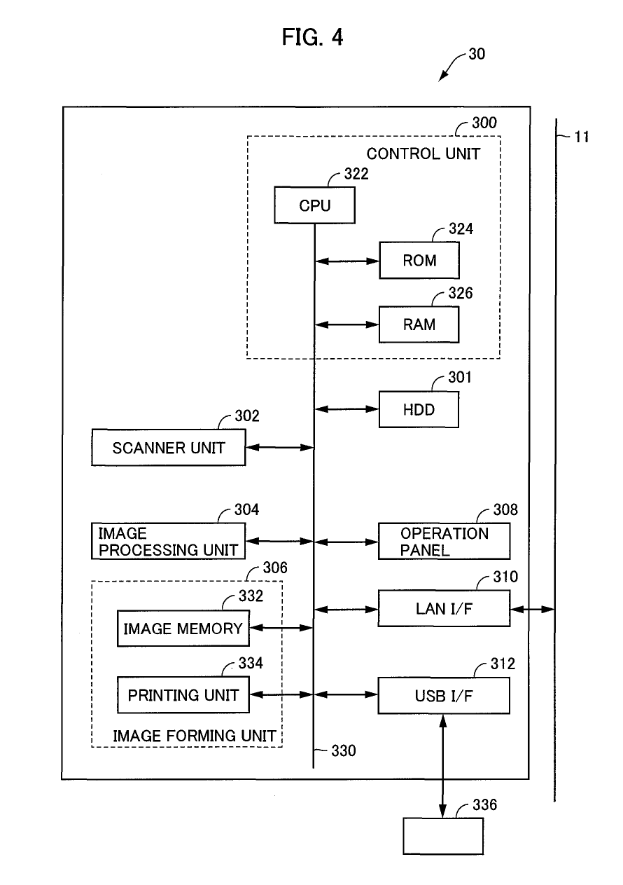

Referring to FIG. 4, MFP 30 includes a control unit 300, an HDD 301, a scanner unit 302, an image processing unit 304, an image forming unit 306, an operation panel 308, an LAN I/F 310 and a USB (Universal Serial Bus) I/F 312.

Control unit 300 is substantially a computer, and it includes a CPU 322, an ROM 324 and an RAM 326. To CPU 322, a bus line 330 is connected, and to bus line 330, ROM 324 and RAM 326 are electrically connected. CPU 322 executes various computer programs in accordance with instructions from operation panel 308 or from external apparatus such as server apparatus 20, 22 and PC 40, and thereby executes operations of various components of MFP 30 and desired processes such as communication with an external apparatus.

Various computer programs mentioned above are stored in advance in ROM 324 or HDD 301 and, when a desired process is to be executed, read from ROM 324 or HDD 301 and transferred to RAM 326. CPU 322 reads a program instruction from an address in RAM 326 designated by a value stored in a register referred to as a program counter, not shown, in CPU 322, and interprets the same. Further, CPU 322 reads data necessary for operation from an address designated by the read instruction, and executes an operation corresponding to the instruction on the data. The result of execution is also stored in the address designated by the instruction, in RAM 326, HDD 301 or a register in CPU 322.

To bus line 330, HDD 301, scanner unit 302, image processing unit 304, image forming unit 306, operation panel 308, LAN I/F 310 and USB I/F 312 are further electrically connected.

HDD 301 stores various data including image data, and a computer program for realizing general operations of MFP 30. In the present embodiment, HDD 301 further stores a program for realizing a service list display process, which will be described later. The program structure for realizing the service list display process of the program will be described later.

HDD 301 further stores first user ID information. The first user ID information indicates a user ID held by a user who is permitted to use MFP 30, that is, an authorized user who is permitted to log-in to MFP 30. The first user ID information is used for user authentication to determine whether the user who is about to use MFP 30 is an authorized user.

Scanner unit 302 includes a document scanning unit including a light source, a reflection mirror, an optical lens and a CCD (Charge Coupled Device) line sensor (all not shown). The document scanning unit forms an image of a reflected light obtained by irradiating an image-bearing surface of a document placed on a platen (not shown) manually by the user or by an automatic document feeder (not shown) with light from the light source. The reflection mirror and the optical lens form the thus obtained image on the CCD line sensor. The CCD line sensor successively performs photo-electric conversion of the image formed by reflected light, and outputs the result as image data to image processing unit 304.

Image processing unit 304 includes an MPU (Micro Processing Unit, not shown). Image processing unit 304 performs various image processing operations on the image data input from scanner unit 302 or from PC 40 to form image data for printing of a prescribed tone, and outputs the data to image forming unit 306.

Image forming unit 306 includes an image memory 332 and a printing unit 334. Image memory 332 includes an RAM, and temporarily stores the image data page by page. In response to an instruction from control unit 300 or the like, image memory 332 temporarily stores the image data for printing to be transmitted to printing unit 334 page by page, and in synchronization with the image formation by printing unit 334, outputs the stored image data for printing to printing unit 334.

Printing unit 334 includes a photoreceptor drum, a charger, an LSU (Laser Scanning Unit), a developer, a transfer device, a cleaning device and a fixing device (all not shown), and a toner cartridge detachably mounted on MFP 30. Printing unit 334 further includes a manual feed tray and first and second paper feed trays (all not shown) that are detachably attached to MFP 30. These paper feed trays are arranged from top to bottom in this order. These paper feed trays hold sheets of recording paper, and feed sheets of recording paper to a paper feeding unit (not shown). The manual feed tray is for allowing the user to set a desired sheet of recording paper. The first and second paper feed trays are to hold sheets of recording paper of different sizes. In response to an instruction from control unit 300 or the like, printing unit 334 forms an image based on the image data transmitted from image memory 332, on the sheet of recording paper fed from any of the paper feed trays through the paper feeding unit.

Operation panel 308 includes a display output unit (not shown in FIG. 4) implemented by a liquid crystal display, and an operation interface unit including operation buttons and a touch panel. The display output unit provides various pieces of information such as information related to the states of various processes and the state of MFP 30 for the user. The operation interface unit provides an interface for the user to operate MFP 30.

Operation panel 308 also provides an interactive operation interface for the user, formed by superposing the liquid crystal display and a touch-panel. The interactive operation interface receives a user instruction related to the overall operation of MFP 30 through the touch-panel, displays the contents of the instruction on the liquid crystal display, and outputs a control signal in accordance with the instruction to control unit 300 or to the MFP of image processing unit 304. By way of example, operation panel 308 displays a list of usable services among various services provided by server apparatuses 20 and 22, on the liquid crystal display. When any one of the displayed services is selected by the user, operation panel 308 outputs a control signal indicating the selected service to control unit 300.

MFP 30 is connected to network 11 through LAN I/F 310, and it is capable of data communication with external apparatuses connected to the network.

USB I/F 312 is a Hot-Plug-supporting interface having a USB port. In the present embodiment, an IC card reader 336 is connected to USB I/F 312. When an IC card (not shown) is inserted to a card insertion slot (not shown), IC card reader 336 reads the user ID included in the IC card, and outputs a read signal including the read information to control unit 300. Control unit 300 performs user authentication based on the user ID included in the read signal and the first user ID information stored in HDD 301.

A power source (not shown) is connected to various components of MFP 30, and a voltage applied from the power source enables operations of various components of MFP 30.

By the operations of various components described above, in accordance with an instruction by a user input through operation panel 308, an instruction from PC 40 or the like, MFP 30 executes any of the copy mode in which a document image is read and an image is printed on a sheet of recording paper, a printer mode in which image data transmitted from PC 40 or the like is received and an image is printed on a sheet of recording paper, a scan mode in which a document image is read and the image data is transmitted to PC 40 or the like, and the document filing mode in which the image data is saved in HDD 301.

[PC 40]

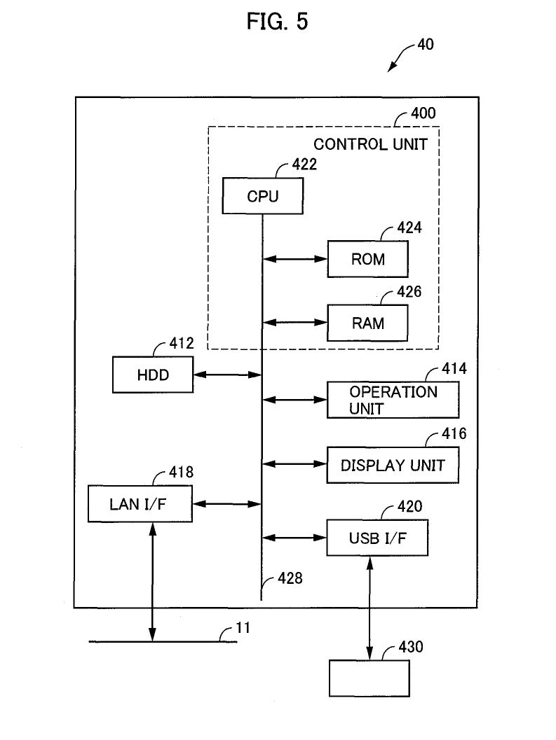

Referring to FIG. 5, PC 40 has the same configuration as server apparatuses 20 and 22 except that different data and programs are stored in an HDD 412 and that a USB I/F 420 to be connected to an IC card reader 430 is provided. Specifically, a control unit 400 including a CPU 422, an ROM 424 and an RAM 426, an operation unit 414, a display unit 416 and an LAN I/F 418 have the same configurations as control unit 100 including CPU 122, ROM 124 and RAM 126, operation unit 114, display unit 116 and LAN I/F 118 of server apparatuses 20 and 22. Only the different points will be described in the following.

HDD 412 stores various data including image data and second user ID information, as well as a program for realizing general operations of PC 40. The second user ID information indicates a user ID held by a user who is permitted to use PC 40, that is, an authorized user who is permitted to log-in to PC 40. The second user ID information is used for user authentication to determine whether the user who is about to use PC 40 is an authorized user.

HDD 412 further stores a printer driver. By executing the printer driver, control unit 400 can realize a process for converting application data to image data for printing (PDL (Page Description Language) data and the like), and a process for transmitting image data designated by the user to MFP 30 and having the image data printed.

USB I/F 420 is a Hot-Plug-supporting interface having a USB port. In the present embodiment, an IC card reader 430 is connected to USB I/F 420. When an IC card (not shown) is inserted to a card insertion slot (not shown), IC card reader 430 reads the user ID included in the IC card, and outputs a read signal including the read information to control unit 400. Control unit 400 performs user authentication based on the user ID included in the read signal and the second user ID information stored in HDD 412.

The user who passed the user authentication can log-in to various services provided by server apparatuses 20 and 22 by an input operation through operation unit 414 of PC 40. Further, the user can instruct execution of various operations such as the printing process to MFP30.

<Software Configuration>

[MFP 30]

As described above, the computer program stored in HDD 301 of MFP 30 is programmed to execute the service list display process. The program for realizing the service list display process is activated when the user logs in to MFP 30.

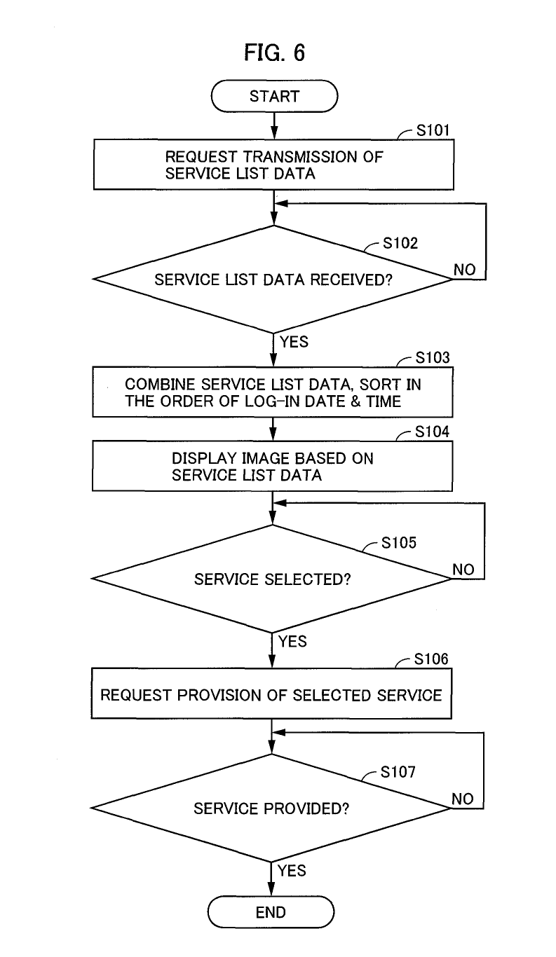

Referring to FIG. 6, the program includes a step S101 of requesting server apparatuses 20 and 22 through network 11 to transmit service list data including a service ID that is logged in with the user ID read at the time of user authentication by MFP 30 and the corresponding piece of information indicating the date and time of log-in.

The program further includes: a step S102 of waiting until the service list data are received from server apparatuses 20 and 22 through network 11; a step S103, executed if it is determined at step S102 that the service list data are received (YES), of combining the received service list data to each other and sorting the service IDs in descending order of the date and time of log-in; and a step S104 of displaying an image based on the service list data, on operation panel 308.

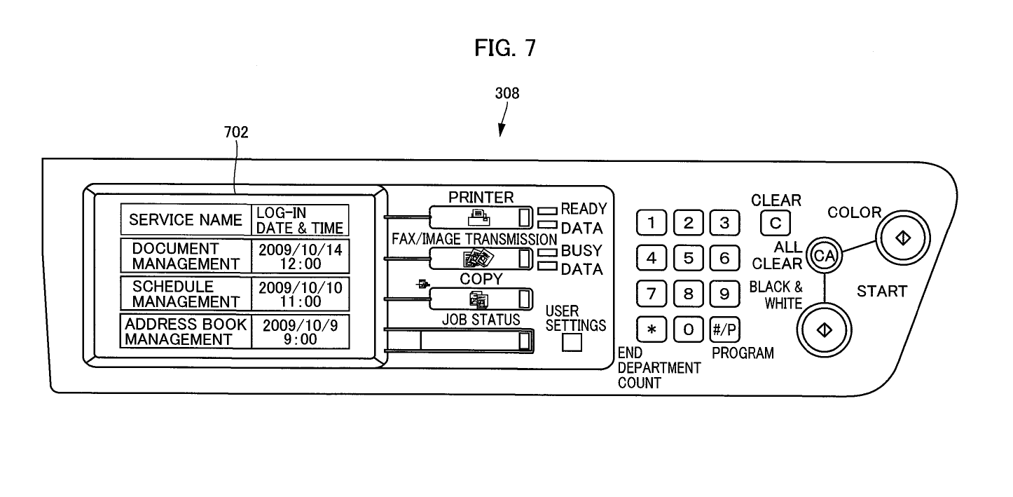

Referring to FIG. 7, at step S104, as the image of sorted service list data, names of various services that are logged in and the corresponding dates and times of log-in are displayed in relation with each other, on display output unit 702 of operation panel 308.

The program further includes: a step S105 of waiting until any one of the displayed services is selected by an input operation through the touch-panel superposed on display output unit 702; and a step S106, executed if it is determined at step S105 that any one of the displayed services is selected (YES), of requesting server apparatus 20 or 22 to provide the selected service.

The program further includes a step S107 of waiting until the selected service is provided from server apparatus 20 (22). If it is determined at step S107 that the selected service is provided (YES), the control ends.

<Operation>

Referring to FIGS. 1 to 7, client server system 10 operates in the following manner in the service list display process. The general operation of client server system 10 except for the operation described below is the same as that of a conventional client server system.

(Operation in Service List Display Process)

A user turns on the power of PC 40. When the power is turned on, a message such as “PLEASE INSERT IC CARD” requesting insertion of the IC card is displayed on display unit 416. The user confirms the message, and inserts his/her IC card to the card insertion slot of IC card reader 430.

When the IC card is inserted, IC card reader 430 reads the user ID included in the IC card, and outputs a read signal including the read user ID to control unit 400.

Control unit 400 performs user authentication based on the user ID included in the read signal and the second user ID information stored in HDD 412. If it is determined that the user is an authorized user by the user authentication, the user is permitted to log-in to PC 40.

Here, it is assumed that log-in history data 200 stored in HDD 112 of server apparatus 20 includes a piece of information 201 indicating the total number N−1 of the pieces of log-in history information, and first to N−1-th pieces of log-in history information 202.

The user logs in to PC 40, and by an input operation through operation unit 414, logs in to one of the services provided by server apparatus 20, for example, the document management service. When the user logs in to the document management service, the N-th piece of log-in history information 202 including the user ID read by IC card reader 430, the service ID indicating the document management service, a piece of information indicating the date and time of log-in, and a piece of information indicating the date and time of last access is additionally stored in log-in history data 200, and the piece of information 201 is overwritten such that the total number of pieces of log-in history information indicates N. Here, the piece of information indicating the date and time of log-in and the piece of information indicating the date and time of last access indicate the same time. Thereafter, until the user logs out of the document management service, the piece of information indicating the date and time of last access is rewritten every time the user accesses the document management service by an input operation through operation unit 414.

After the log-in to the document management service, the user turns on the power of MFP 30. When the power is turned on, a message such as “PLEASE INSERT IC CARD” requesting insertion of the IC card is displayed on operation panel 308. The user confirms the message, and inserts his/her IC card to the card insertion slot of IC card reader 336.

When the IC card is inserted, IC card reader 336 reads the user ID included in the IC card, and outputs a read signal including the read user ID to control unit 300.

Control unit 300 performs user authentication based on the user ID included in the read signal and the first user ID information stored in HDD 301. If it is determined that the user is an authorized user by the user authentication, the user is permitted to log-in to MFP 30.

When the user logs in to MFP 30, control unit 300 requests server apparatuses 20 and 22 to transmit service list data including the service ID to which the user is logged in with the user ID read at the time of user authentication in MFP 30 and a corresponding piece of information indicating the date and time of log-in (step S101).

Receiving the request from MFP 30, control unit 100 of server apparatuses 20 and 22 searches in the log-in history data 200 stored in HDD 112, and finds and extracts log-in history information 202 including the user ID read from the IC card at the time of authentication in MFP 30 and not including a piece of information indicating the date and time of log-out. Then, a service list data is formed, in which the service ID included in the extracted log-in history information 202 and the corresponding piece of information indicating the date and time of log-in are shown in relation to each other. The formed service list data is transmitted to MFP 30.

When the service list data from server apparatuses 20 and 22 are received (YES at step S102), control unit 300 combines the received service list data, and sorts the service IDs in the descending order of the date and time of log-in (step S103). An image based on the sorted service list data (see FIG. 7) is displayed on operation panel 308 (step S104).

The user confirms the displayed image, and by an input operation through the touch-panel formed superposed on display output unit 702, selects any one of the displayed services (in the present embodiment, the document management service).

When the service is selected by the user (YES at S105), control unit 300 requests server apparatus 20 or 22 to provide the selected service (step S106).

When provision of the service is requested, server apparatus 20 or 22 provide the requested service (here, the document management service) to MFP 30. Thus, it becomes possible to use the document management service by MFP 30 (YES at step S107).

When use of the document management service ends, the user logs out of the document management service by an input operation of operation unit 414 of PC 40. When log-out takes place, a piece of information indicating the date and time of log-out is written to the N-th piece of log in history information 202.

### First Modification

The first modification of client server system 10 has the same configuration as client server system 10 in accordance with the first embodiment except that the program for realizing the service list display process is different.

<Software Configuration>

[MFP 30]

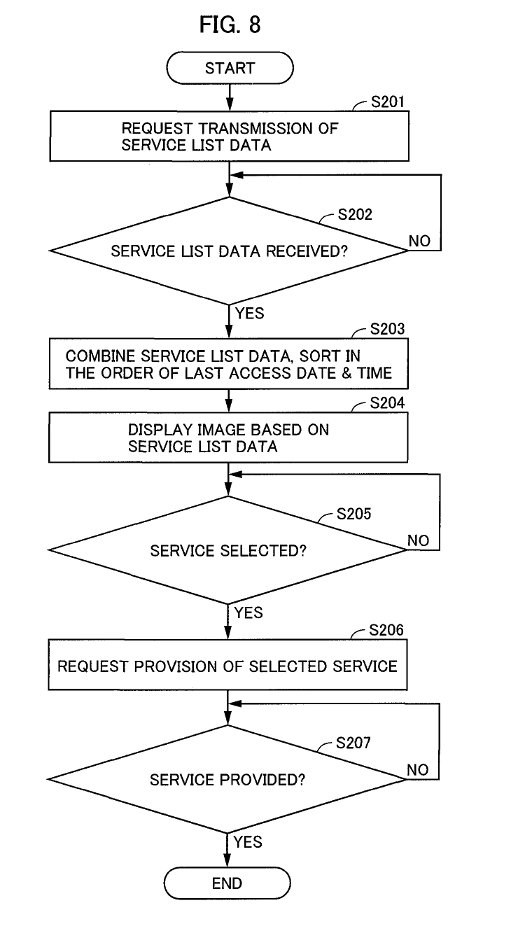

Referring to FIG. 8, in the program for realizing the service list display process in accordance with the present modification, process steps (steps S202, S204 to S207) except for steps S201 and S203 are the same as the process steps (steps S102, S104 to S107) executed by the program shown in FIG. 6. In the following, different steps will be described.

Referring to FIG. 8, the program includes the step S201 of requesting server apparatuses 20 and 22 through network 11 to transmit service list data including a service ID that is logged in with the user ID read at the time of user authentication by MFP 30 and the corresponding piece of information indicating the date and time of last access.

The program further includes a step S203, executed if it is determined at step S202 that the service list data are received (YES), of combining the received service list data and sorting the service IDs in the descending of order of the date and time of last access.

<Operation>

Referring to FIG. 8, the first modification of client server system 10 operates in the following manner in the service list display process. The operation of the first modification of client server system 10 except for the operation described below is the same as the operation of client server system 10 in accordance with the first embodiment described above.

(Operation in Service List Display Process)

When the user logs in to MFP 30, control unit 300 requests server apparatuses 20 and 22 to transmit service list data including the service ID to which the user is logged in with the user ID read at the time of user authentication in MFP 30 and a corresponding piece of information indicating the date and time of last access (step S201).

Receiving the request from MFP 30, control unit 100 of server apparatuses 20 and 22 searches in the log-in history data 200 stored in HDD 112, and finds and extracts log-in history information 202 including the user ID read from the IC card at the time of authentication in MFP 30 and not including a piece of information indicating the date and time of log-out. Then, a service list data is formed, in which the service ID included in the extracted log-in history information 202 and the corresponding piece of information indicating the date and time of last access are shown in relation to each other. The formed service list data is transmitted to MFP 30.

When the service list data from server apparatuses 20 and 22 are received (YES at step S202), control unit 300 combines the received service list data, and sorts the service IDs in the descending order of the date and time of last access (step S203). An image based on the sorted service list data is displayed on operation panel 308 (step S204).

### Second Modification

The second modification of client server system 10 has the same configuration as client server system 10 in accordance with the first embodiment except that the program for realizing the service list display process is different.

<Software Configuration>

[MFP 30]

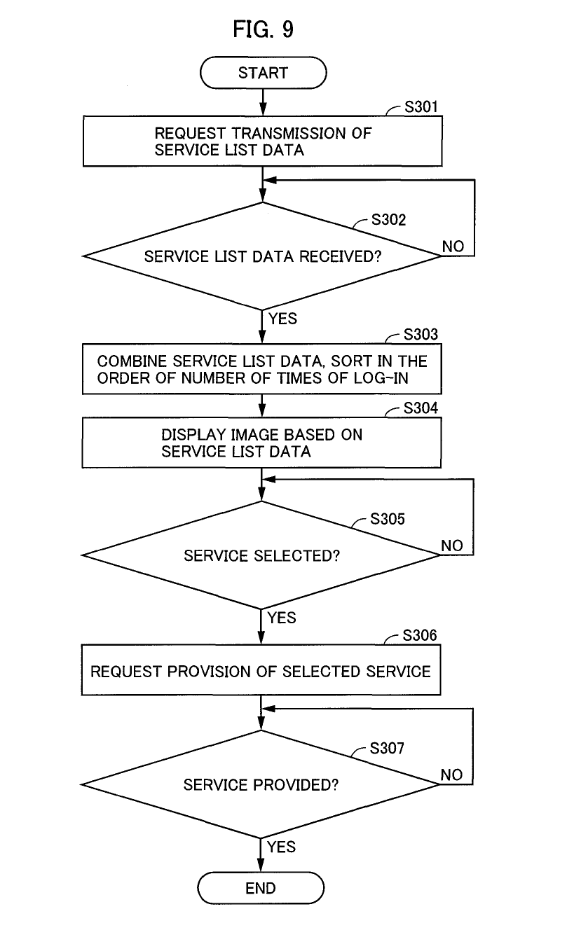

Referring to FIG. 9, in the program for realizing the service list display process in accordance with the present modification, process steps (steps S302, S304 to S307) except for steps S301 and S303 are the same as the process steps (steps S102, S104 to S107) executed by the program shown in FIG. 6. In the following, different steps will be described.

Referring to FIG. 9, the program includes the step S301 of requesting server apparatuses 20 and 22 through network 11 to transmit service list data including a service ID that is logged in with the user ID read at the time of user authentication by MFP 30 and the corresponding piece of information indicating the number of times of log-in. The number of times of log-in is a numerical value indicating how many times one user logged in to the same service.

The program further includes a step S303, executed if it is determined at step S302 that the service list data are received (YES), of combining the received service list data and sorting the service IDs in the descending of order of the number of times of log-in.

### <Operation>

Referring to FIG. 9, the second modification of client server system 10 operates in the following manner in the service list display process. The operation of the second modification of client server system 10 except for the operation described below is the same as the operation of client server system 10 in accordance with the first embodiment described above.

(Operation in Service List Display Process)

When the user logs in to MFP 30, control unit 300 requests server apparatuses 20 and 22 to transmit service list data including the service ID to which the user is logged in with the user ID read at the time of user authentication in MFP 30 and a corresponding piece of information indicating the number of times of log-in (step S301).

Receiving the request from MFP 30, control unit 100 of server apparatuses 20 and 22 searches in the log-in history data 200 stored in HDD 112, and finds and extracts log-in history information 202 including the user ID read from the IC card at the time of authentication in MFP 30 and not including a piece of information indicating the date and time of log-out. Then, a service list data is formed, in which the service ID included in the extracted log-in history information 202 and the corresponding piece of information indicating the number of times of log-in are shown in relation to each other. The formed service list data is transmitted to MFP 30.

When the service list data from server apparatuses 20 and 22 are received (YES at step S302), control unit 300 combines the received service list data, and sorts the service IDs in the descending order of the number of times of log-in (step S303). An image based on the sorted service list data is displayed on operation panel 308 (step S304).

### Third Modification

The third modification of client server system 10 has the same configuration as client server system 10 in accordance with the first embodiment described above except that HDD 301 stores a usable service management table, and that the program for realizing the service list display process is different.

HDD 301 stores the usable service management table for limiting services usable from MFP 30. Table 1 below is an example of the usable service management table.

TABLE 1

| | Usable | Usable | Usable | Usable |
|---|---|---|---|---|
| User ID | service 1 | service 2 | server 1 | server 2 |
| Tanaka | File | Address book | Server | Server |
| | management | management | apparatus 20 | apparatus 22 |
| Matsui | File | | Server | |
| | management | | apparatus 20 | |
| Yoshida | | | | |

Referring to Table 1, the usable service management table stores user IDs, and, the services and the server apparatuses usable by the users corresponding to the user IDs, in relation to each other. By way of example, if the user ID of the user who is logged in to MFP 30 is “Tanaka,” the corresponding user can use the file management service and the address book management service provided by server apparatuses 20 and 22. If the user ID of the user who is logged in to MFP 30 is “Matsui,” the corresponding user can use the file management service provided by server apparatus 20. If the user ID of the user who is logged in to MFP 30 is “Yoshida,” the corresponding user cannot use any of the services provided by server apparatus 20 and 22. Various pieces of information in the usable service management table are registered in advance by an administrator or the like of MFP 30.

<Software Configuration>

[MFP 30]

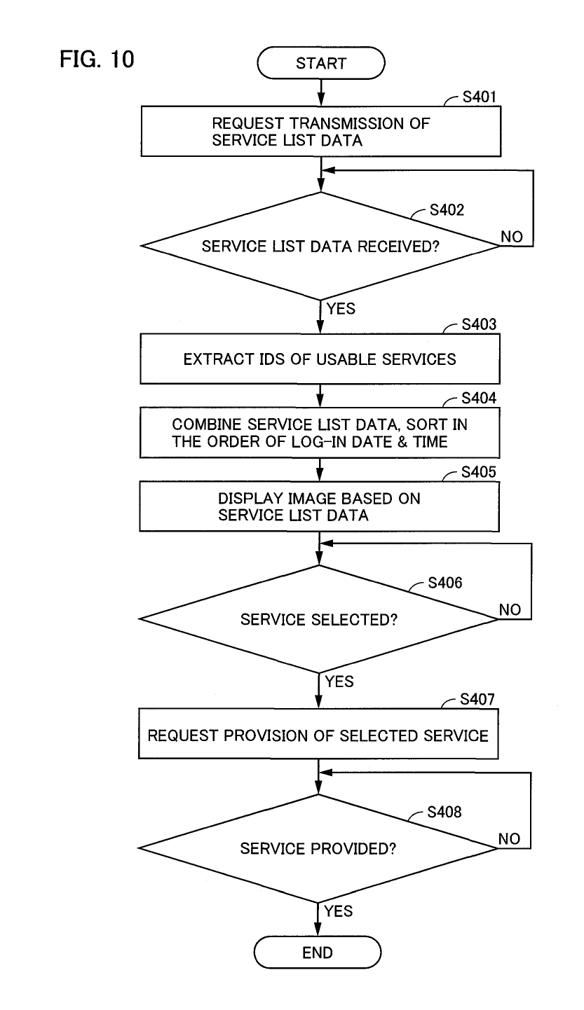

Referring to FIG. 10, in the program for realizing the service list display process in accordance with the present modification, process steps (steps S401, S402, S405 to S408) except for steps S403 and S404 are the same as the process steps (steps S101, S102, S104 to S107) executed by the program shown in FIG. 6. In the following, different steps will be described.

Referring to FIG. 10, the program includes: a step S403, executed if it is determined at step S402 that the service list data are received (YES), of extracting, based on the usable service management table, service IDs of services usable by the user corresponding to the user ID who is logged in to MFP 30 from the received service list data; and a step S404 of combining the service list data including only the extracted service IDs and sorting the service IDs in the descending order of the date and time of log-in.

<Operation>

Referring to FIG. 10, the third modification of client server system 10 operates in the following manner in the service list display process. The operation of the third modification of client server system 10 except for the operation described below is the same as the operation of client server system 10 in accordance with the first embodiment described above.

(Operation in Service List Display Process)

When the service list data from server apparatuses 20 and 22 are received (YES at step S402), control unit 300 extracts service IDs of services usable by the user corresponding to the user ID who is logged in to MFP 30, from the received service list data, based on the usable service management table (step S403). Then, the service list data including only the extracted service IDs are combined, and the service IDs are sorted in the descending order of the date and time of log-in (step S404). Thus, on operation panel 308, only the services that are logged in and usable from MFP 30 are displayed, whereby convenience for the user can be improved.

In the third modification described above, the services usable from MFP 30 are limited by three pieces of information, that is, the user ID, the usable service and the server apparatus, stored in the usable service list data. The present invention, however, is not limited to such an embodiment. By way of example, the services usable from MFP 30 may be limited only by the information of user ID, only by the information of usable service, or only by the information of usable server apparatus.

The third modification described above may be applied to the first or second modification of the first embodiment.

### Second Embodiment

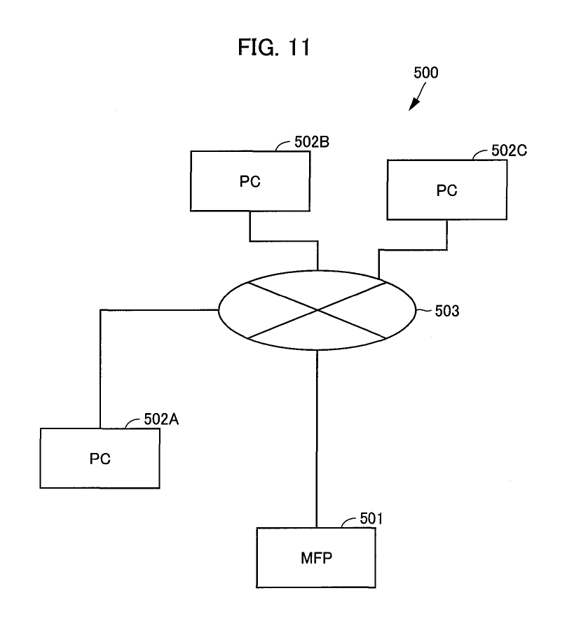

Referring to FIG. 11, a client server system 500 includes an MFP 501 and PCs 502A to 502C. MFP 501 and PCs 502A to 502C are connected to each other through a network 503 implemented, for example, by a LAN line, and capable of data communication with each other.

PCs 502A to 502C have the same configuration as PC 40 described above except that the PCs each store log-in history data 200 in HDD, form the service list data and provide the data to MFP 501, and provide various services to the user, including the file management service as will be described later. Specifically, the PCs have the functions realized by server apparatuses 20 and 22 described above.

MFP 501 has the same configuration as MFP 30 described above, except that it stores, in the HDD, a program for realizing a scan transmission destination display process, in place of the program for realizing the service list display process described above.

The numbers of MFP 501 and PCs 502A to 502C are not limited to those shown in FIG. 11. Further, client server system 500 may include other peripherals in addition to the apparatuses described above.

(File Management Service)

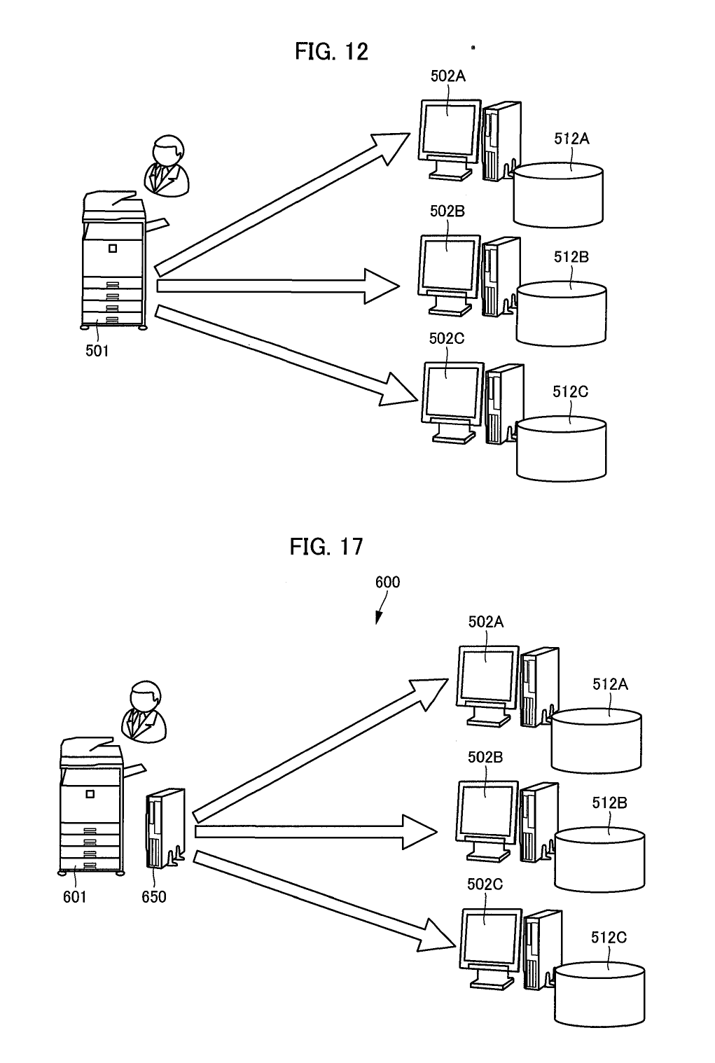

Referring to FIG. 12, HDDs 512A to 512C provided in PCs 502A to 502C store scan image data, in addition to various data such as log-in history data 200 and various programs such as the printer driver. The scan image data refers to image data generated by scanner unit of MFP 501 reading a document image. It is possible for the user to designate a PC 502 as a destination in which the scan image data is saved, by an input operation through the operation panel of MFP 501. Thus, the scan image data is transmitted to the designated PC 502, and stored in HDD 512 of PC 502 as the transmission destination. The service in which PC 502 serves as a destination for storing the scan image data will be referred to as a file management service in the following. In the present embodiment, it is assumed that the service ID corresponding to the file management service includes a piece of information for distinguishing and identifying a PC 502 as the source of the file management service.

<Software Configuration>

[MFP 501]

As described above, the computer program stored in the HDD of MFP 501 is programmed to execute the scan transmission destination display process. The program for realizing the scan transmission destination display process is activated when the user logs in to MFP 501.

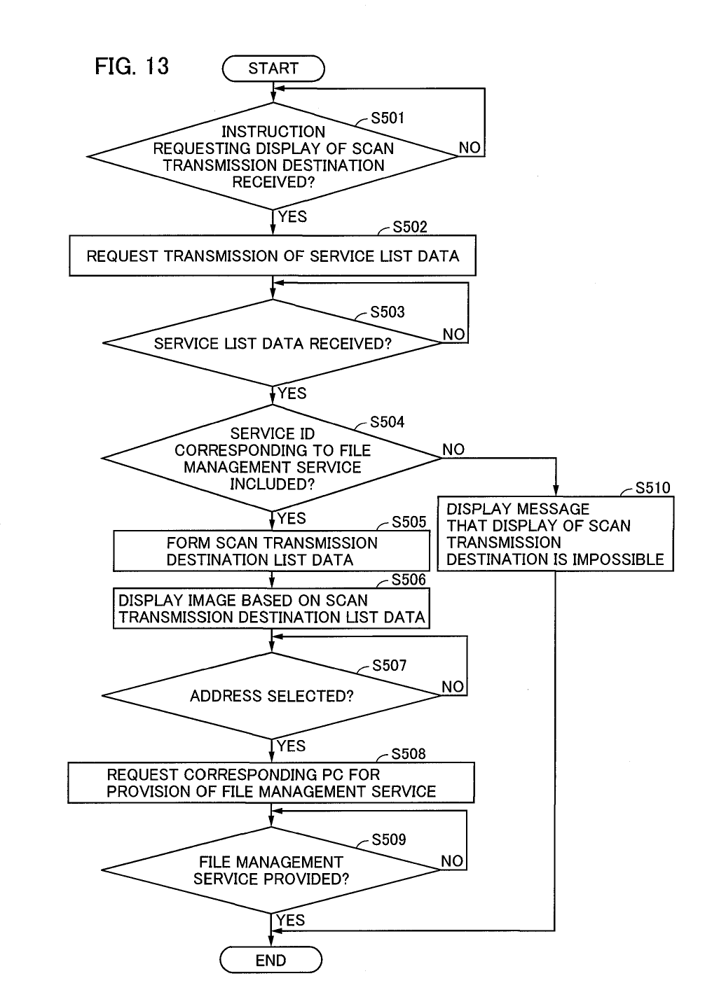

Referring to FIG. 13, the program includes: a step S501 of waiting until an instruction requesting display of a transmission destination of scan image data is given from the operation panel of MFP 501; and a step S502, executed if it is determined at step S501 that the instruction requesting display of transmission destination is given (YES), of requesting PCs 502A to 502C through the network 503 to transmit the service list data including the service ID that is logged in with the user ID read at the time of user authentication by MFP 501 and the corresponding piece of information indicating the date and time of log-in.

The program further includes: a step S503 of waiting until the service list data are received from PCs 502A to 502C through network 503; and a step S504, executed if it is determined at step S503 that the service list data are received (YES), of determining whether or not the received service list data include a service ID corresponding to the file management service provided by PCs 502A to 502C.

The program further includes: a step S505, executed if it is determined at step S504 that the corresponding service ID is included (YES), of extracting only the service IDs corresponding to the file management service, sorting the service IDs in the descending order of the date and time of log-in and thereby forming the scan transmission destination list data; and a step S506 of displaying, on the operation panel of MFP 501, an image based on the scan transmission destination list data.

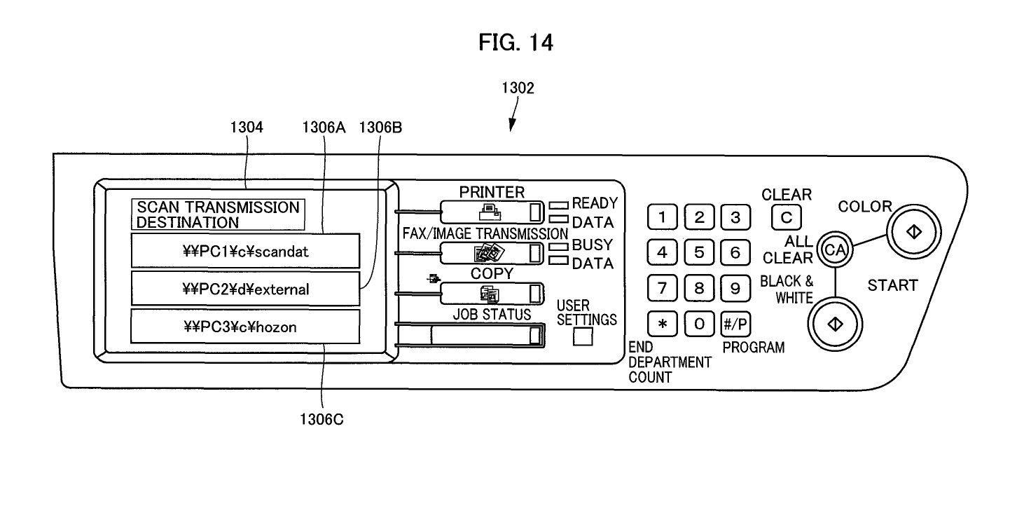

Referring to FIG. 14, at step S506, on a display output portion 1304 of an operation panel 1302 of MFP 501, as the image based on the scan transmission destination list data, addresses of PCs 502 providing the file management service are displayed in the descending order of date and time of log-in. Addresses 1306A to 1306C shown in FIG. 14 indicate addresses of PCs 502A to 502C, respectively.

The program further includes: a step S507 of waiting until any one of the displayed addresses is selected by an input operation from the touch-panel formed superposed on display output portion 1304; and a step S508, executed if it is determined at step S507 that any of the displayed addresses is selected (YES), of requesting the PC 502 corresponding to the selected address, to provide the file management service.

The program further includes a step S509 of waiting until the file management service is provided from PC 502 to which the request was made.

The program further includes a step S510, executed if it is determined at step S504 that the corresponding service ID is not included (NO), of displaying, on operation panel 1302 of MFP 501, a message that the destination of transmitting scan image data cannot be displayed. If it is determined at step S509 that the file management service is provided (YES), or after the process of step S510, the control ends.

<Operation>

Referring to FIGS. 11 to 14, client server system 500 operates in the following manner in the scan transmission destination display process. The general operation of client server system 500 except for the operation described below is the same as that of a conventional client server system.

(Operation in Scan Transmission Destination Display Process)

A user turns on the power of PCs 502A to 502C. When the power is turned on, a message such as “PLEASE INSERT IC CARD” requesting insertion of the IC card is displayed on a display unit of PCs 502A to 502C. The user confirms the message, and inserts his/her IC card to the card insertion slot of an IC card reader of PCs 502A to 502C.

When the IC card is inserted, the IC card reader reads the user ID included in the IC card, and outputs a read signal including the read user ID to the control unit of PCs 502A to 502C.

The control unit performs user authentication based on the user ID included in the read signal and the second user ID information stored in HDDs 512A to 512C. If it is determined that the user is an authorized user by the user authentication, the user is permitted to log-in to PCs 502A to 502C.

Here, it is assumed that log-in history data 200 stored in HDDs 512A to 512C includes a piece of information 201 indicating the total number N−1 of the pieces of log-in history information, and first to N−1-th pieces of log-in history information 202.

The user logs in to PCs 502A to 502C, and by an input operation through the operation unit, logs in to the file management service as one of the services provided by PCs 502A to 502C. When the user logs in to the file management service, the N-th piece of log-in history information 202 including the user ID read by the IC card reader of PCs 502A to 502C, the service ID indicating the file management service, a piece of information indicating the date and time of log-in, and a piece of information indicating the date and time of last access is additionally stored in log-in history data 200, and the piece of information 201 is overwritten such that the total number of pieces of log-in history information indicates N. Here, the piece of information indicating the date and time of log-in and the piece of information indicating the date and time of last access indicate the same time. Thereafter, until the user logs out of the file management service, the piece of information indicating the date and time of last access is rewritten every time the user accesses the file management service by an input operation through the operation unit.

After the log-in to the file management service, the user turns on the power of MFP 501. When the power is turned on, a message such as “PLEASE INSERT IC CARD” requesting insertion of the IC card is displayed on operation panel 1302. The user confirms the message, and inserts his/her IC card to the card insertion slot of the IC card reader of MFP 501.

When the IC card is inserted, the IC card reader reads the user ID included in the IC card, and outputs a read signal including the read user ID to the control unit of MFP 501.

The control unit performs user authentication based on the user ID included in the read signal and the first user ID information stored in the HDD of MFP 501. If it is determined that the user is an authorized user by the user authentication, the user is permitted to log-in to MFP 501.

The user logs in to MFP 501, places a document on a platen of the scanner unit of MFP 501, and issues an instruction requesting display of transmission destination of scan image data, using operation panel 1302 of MFP 501.

When the instruction requesting display of transmission destination is issued (YES at step S501), the control unit of MFP 501 requests PCs 502A to 502C to transmit the service list data including the service ID that is logged in with the user ID read at the time of user authentication by MFP 501 and the corresponding piece of information indicating the date and time of log-in (step S502).

Receiving the request from MFP 501, the control unit of PCs 502A to 502C searches in the log-in history data 200 stored in the HDD, and finds and extracts log-in history information 202 including the user ID read from the IC card at the time of authentication in MFP 501 and not including a piece of information indicating the date and time of log-out. Then, a service list data is formed, in which the service ID included in the extracted log-in history information 202 and the corresponding piece of information indicating the date and time of log-in are shown in relation to each other. The formed service list data is transmitted to MFP 501.

When the service list data are received from PCs 502A to 502C (YES at step S503), the control unit of MFP 501 determines whether or not the received service list data include a service ID that corresponds to the file management service provided by PCs 502A to 502C (step S504). Determining that the corresponding service ID is included (YES at step S504), the control unit of MFP 501 extracts only the service IDs corresponding to the file management services provided by PCs 502A to 502C from the service list data, and sorts the same in the descending order of the date and time of log-in, thereby to form the scan transmission destination list data (step S505). An image (see FIG. 14) based on the scan transmission destination list data is displayed on operation panel 1302 of MFP 501 (step S506).

The user confirms the displayed image, and by an input operation through the touch-panel formed superposed on display output portion 1304, selects any one of displayed addresses 1306A to 1306C, and thereby selects any one of PCs 502A to 502C as the desired transmission destination.

When an address is selected by the user (YES at step S507), the control unit of MFP 501 requests any of PCs 502A to 502C that corresponds to the selected address, to provide the file management service (step S508).

In response to the request for the provision of file management service, the corresponding one of PCs 502A to 502C provides the file management service to MFP 501. Thus, it becomes possible to use the file management service from MFP 501 (YES at step S509).

The scanner unit of MFP 501 reads image information of the document, and transmits scan image data based on the read image information to the selected one of PCs 502A to 502C. Receiving the scan image data, the corresponding one of PCs 502A to 502C saves the received scan image data in the corresponding one of HDDs 512A to 512C.

When the scan image data is saved, the user logs out of the file management service by an input operation through the operation unit of PCs 502A to 502C. After log-out, the information indicating the date and time of log-out is written to the N-th log-in history information 202.

If it is determined that the corresponding service ID is not included (NO at step S504), a message that the destination of transmitting scan image data cannot be displayed is displayed on operation panel 1302 of MFP 501 (step S510).

### First Modification

The first modification of client server system 500 has the same configuration as client server system 500 in accordance with the embodiment described above, except that a program for realizing an address book saving destination display process is stored in the HDD of MFP 501 in place of the program for realizing the scan transmission destination display process, and that PCs 502A to 502C provide the address book management service in place of the file management service.

(Address Book Management Service)

HDDs 512A to 512C store address book data, in addition to various data such as log-in history data 200 and various programs such as the printer driver. The address book data stores names of transmission destinations of facsimile communication, in association with pieces of destination information including FAX numbers and mail addresses.

It is possible for the user to designate a PC 502 as a destination in which the address book is saved, by an input operation through the operation panel 1302 of MFP 501. Thus, an image based on the address book data saved in HDD 512 of the designated PC 502 is displayed on operation panel 1302 of MFP 501. The user confirms the displayed image, and selects a desired piece of destination information by an input operation through operation panel 1302 of MFP 501. Accordingly, the scan image data is transmitted to the selected destination. The service in which PC 502 provides a destination for saving the address book data as described above will be referred to as an address book management service in the following. In the present embodiment, it is assumed that the service ID corresponding to the address book management service includes a piece of information for distinguishing and identifying a PC 502 as the source of the address book management service.

<Software Configuration>

[MFP 501]

As described above, the computer program stored in the HDD of MFP 501 is programmed to execute the address book saving destination display process. The program for realizing the address book saving destination display process is activated when the user logs in to MFP 501.

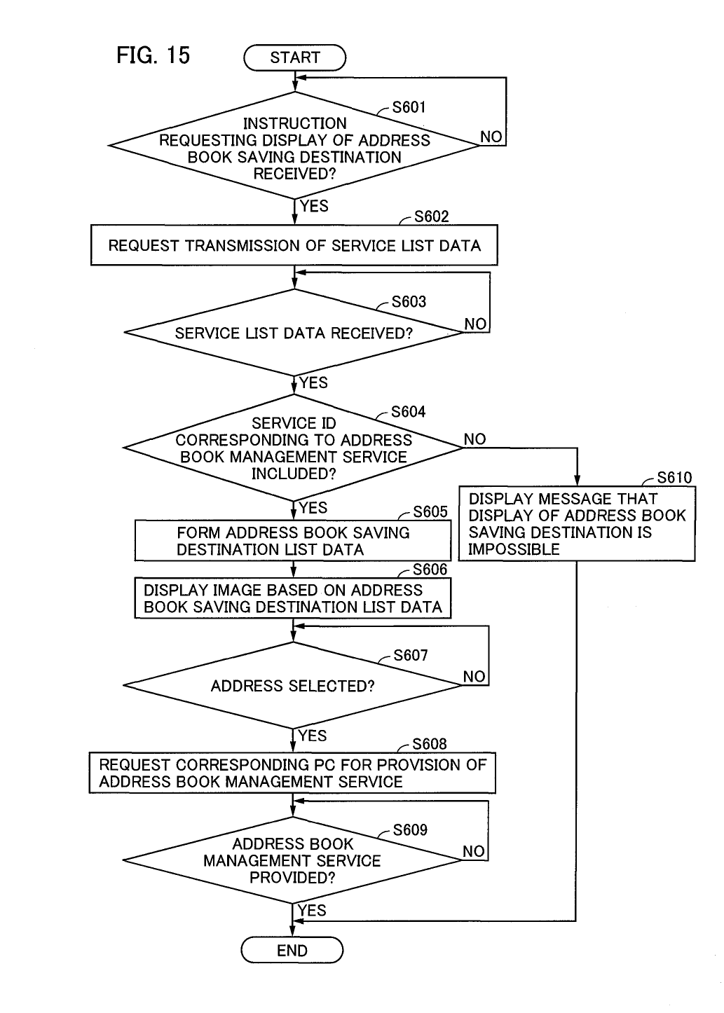

Referring to FIG. 15, the program includes: a step S601 of waiting until an instruction requesting display of address book saving destination is given from the operation panel 1302 of MFP 501; and a step S602, executed if it is determined at step S601 that the instruction requesting display of address book saving destination is given (YES), of requesting PCs 502A to 502C through the network 503 to transmit the service list data including the service ID that is logged in with the user ID read at the time of user authentication by MFP 501 and the corresponding piece of information indicating the date and time of log-in.

The program further includes: a step S603 of waiting until the service list data are received from PCs 502A to 502C through network 503; and a step S604, executed if it is determined at step S603 that the service list data are received (YES), of determining whether or not the received service list data include a service ID corresponding to the address book management service provided by PCs 502A to 502C.

The program further includes: a step S605, executed if it is determined at step S604 that the corresponding service ID is included (YES), of extracting only the service IDs corresponding to the address book management service from the service list data, sorting the service IDs in the descending order of the date and time of log-in and thereby forming the address book saving destination list data; and a step S606 of displaying, on the operation panel 1302 of MFP 501, an image (not shown) based on the address book saving destination list data. At step S606, on a display output portion 1304 of an operation panel 1302 of MFP 501, as the image based on the address book saving destination list data, addresses of PCs 502 providing the address book management service are displayed in the descending order of date and time of log-in.

The program further includes: a step S607 of waiting until any one of the displayed addresses is selected by an input operation from the touch-panel formed superposed on display output portion 1304; and a step S608, executed if it is determined at step S607 that any of the displayed addresses is selected (YES), of requesting the PC 502 corresponding to the selected address, to provide the address book management service.

The program further includes a step S609 of waiting until the address book management service is provided from PC 502 to which the request was made.

The program further includes a step S610, executed if it is determined at step S604 that the corresponding service ID is not included (NO), of displaying, on operation panel 1302 of MFP 501, a message that the address book saving destination cannot be displayed. If it is determined at step S609 that the address book management service is provided (YES), or after the process of step S610, the control ends.

<Operation>

Referring to FIG. 15, the first modification of client server system 500 operates in the following manner in the address book saving destination display process. The operation of the first modification of client server system 500 is the same as the operation of client server system 500 in accordance with the second embodiment described above, except for the operation described below.

(Operation in Address Book Saving Destination Display Process)

The user logs in to PCs 502A to 502C, and by an input operation through the operation unit, logs in to the address book management service as one of the services provided by PCs 502A to 502C. When the user logs in to the address book management service, the N-th piece of log-in history information 202 including the user ID read by the IC card reader of PCs 502A to 502C, the service ID indicating the file management service, a piece of information indicating the date and time of log-in, and a piece of information indicating the date and time of last access is additionally stored in log-in history data 200, and the piece of information 201 is overwritten such that the total number of pieces of log-in history information indicates N. Here, the piece of information indicating the date and time of log-in and the piece of information indicating the date and time of last access indicate the same time. Thereafter, until the user logs out of the address book management service, the piece of information indicating the date and time of last access is rewritten every time the user accesses the address book management service by an input operation through the operation unit.

The user logs in to MFP 501, places a document on a platen of the scanner unit of MFP 501, and issues an instruction requesting display of address book saving destination, using operation panel 1302 of MFP 501.

When the instruction requesting display of address book saving destination is issued (YES at step S601), the control unit of MFP 501 requests PCs 502A to 502C to transmit the service list data including the service ID that is logged in with the user ID read at the time of user authentication by MFP 501 and the corresponding piece of information indicating the date and time of log-in (step S602).

Receiving the request from MFP 501, the control unit of PCs 502A to 502C searches in the log-in history data 200 stored in the HDD, and finds and extracts log-in history information 202 including the user ID read from the IC card at the time of user authentication in MFP 501 and not including a piece of information indicating the date and time of log-out. Then, a service list data is formed, in which the service ID included in the extracted log-in history information 202 and the corresponding piece of information indicating the date and time of log-in are shown in relation to each other. The formed service list data is transmitted to MFP 501.

When the service list data are received from PCs 502A to 502C (YES at step S603), the control unit of MFP 501 determines whether or not the received service list data include a service ID that corresponds to the address book management service provided by PCs 502A to 502C (step S604). Determining that the corresponding service ID is included (YES at step S604), the control unit of MFP 501 extracts only the service IDs corresponding to the address book management services provided by PCs 502A to 502C from the service list data, and sorts the same in the descending order of the date and time of log-in, thereby to form the address book saving destination list data (step S605). An image based on the address book saving destination list data is displayed on operation panel 1302 of MFP 501 (step S606).

The user confirms the displayed image, and by an input operation through the touch-panel formed superposed on display output portion 1304, selects any one of displayed addresses 1306A to 1306C, and thereby selects any one of PCs 502A to 502C as the desired address book saving destination.

When an address is selected by the user (YES at step S607), the control unit of MFP 501 requests any of PCs 502A to 502C that corresponds to the selected address, to provide the address book management service (step S608).

In response to the request for the provision of address book management service, the corresponding one of PCs 502A to 502C provides the address book management service to MFP 501. Thus, it becomes possible to use the address book management service from MFP 501 (YES at step S609).

The control unit of MFP 501 obtains address book data saved in the HDD of the selected one of PCs 502A to 502C. An image based on the obtained address book data is displayed on operation panel 1302 of MFP 501. The user confirms the displayed image, and by an input operation through operation panel 1302 of MFP 501, selects a piece of desired destination information.

After selection of the destination information, the scanner unit of MFP 501 reads image information of the document, and transmits scan image data based on the read image information to the selected destination.

When transmission of the scan image data ends, the user logs out of the address book management service by an input operation through the operation unit of PCs 502A to 502C. After log-out, the information indicating the date and time of log-out is written to the N-th log-in history information 202.

If it is determined that the corresponding service ID is not included (NO at step S604), a message that the address book saving destination cannot be displayed is displayed on operation panel 1302 of MFP 501 (step S610).

### Second Modification

The second modification of client server system 500 has the same configuration as client server system 500 in accordance with the embodiment described above except that a program for realizing a print data saving destination display process, which will be described later, is stored in the HDD of MFP 501 in place of the program for realizing the scan transmission destination display process, and that PCs 502A to 502C provide a print data management service in place of the file management service.

(Print Data Management Service)

HDDs 512A to 512C store print data, in addition to various data such as log-in history data 200 and various programs such as the printer driver. The print data refers to image data of which printing is desired by the user, stored in advance by the user in HDDs 512A to 512C.

It is possible for the user to designate a PC 502 as a print data saving destination, by an input operation through the operation panel 1302 of MFP 501. Thus, an image based on list data of print data showing all print data saved in HDD 512 of the designated PC 502 is displayed on operation panel 1302 of MFP 501. The user confirms the displayed image, and selects a print data by an input operation through operation panel 1302 of MFP 501. MFP 501 obtains the selected print data, and an image based on the obtained print data is printed by the image forming unit. The service in which PC 502 provides the destination for saving the print data will be denoted as a print data management service in the following. In the present embodiment, it is assumed that the service ID corresponding to the print data management service includes a piece of information for distinguishing and identifying a PC 502 as the source of the print data management service.

The method of obtaining print data by MFP 501 is not specifically limited and any general method in the field of art may be used. By way of example, if the file type of print data is PDF (Portable Document Format), a method of obtaining the data using a direct print function of MFP 501 may be used.

<Software Configuration>

[MFP 501]

As described above, the computer program stored in the HDD of MFP 501 is programmed to execute the print data saving destination display process. The program for realizing the print data saving destination display process is activated when the user logs in to MFP 501.

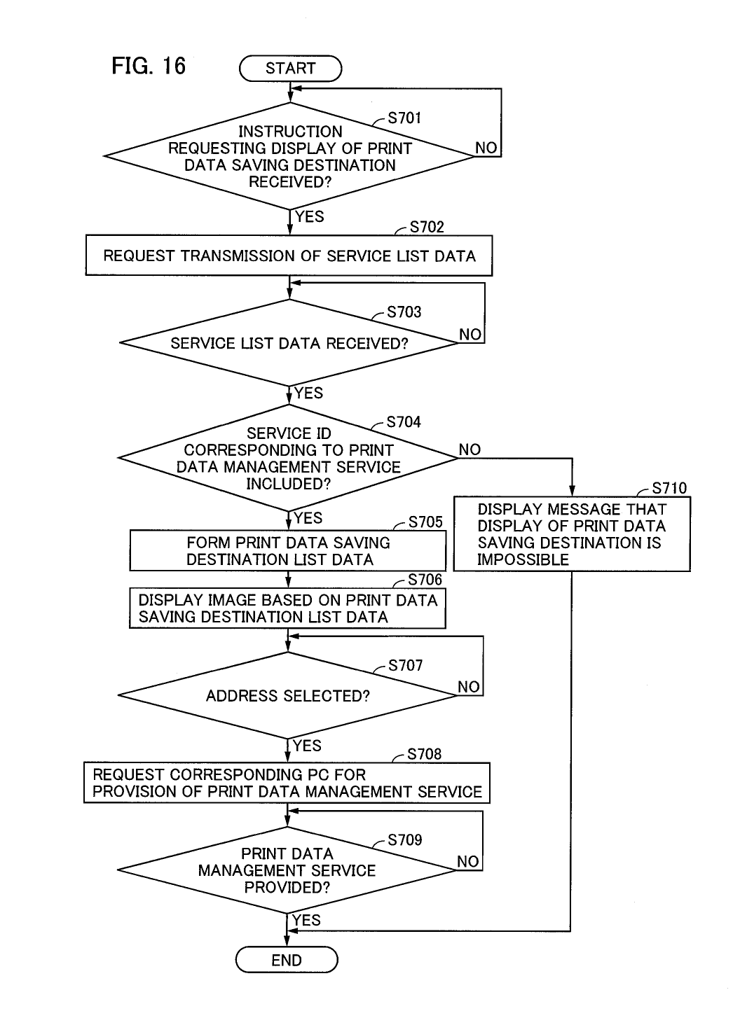

Referring to FIG. 16, the program includes: a step S701 of waiting until an instruction requesting display of print data saving destination is given from the operation panel 1302 of MFP 501; and a step S702, executed if it is determined at step S701 that the instruction requesting display of print data saving destination is given (YES), of requesting PCs 502A to 502C through the network 503 to transmit the service list data including the service ID that is logged in with the user ID read at the time of user authentication by MFP 501 and the corresponding piece of information indicating the date and time of log-in.

The program further includes: a step S703 of waiting until the service list data are received from PCs 502A to 502C through network 503; and a step S704, executed if it is determined at step S703 that the service list data are received (YES), of determining whether or not the received service list data include a service ID corresponding to the print data management service provided by PCs 502A to 502C.

The program further includes: a step S705, executed if it is determined at step S704 that the corresponding service ID is included (YES), of extracting only the service IDs corresponding to the print data management service from the service list data, sorting the service IDs in the descending order of the date and time of log-in and thereby forming the print data saving destination list data; and a step S706 of displaying, on operation panel 1302 of MFP 501, an image (not shown) based on the print data saving destination list data. At step S706, on a display output portion 1304 of an operation panel 1302 of MFP 501, as the image based on the print data saving destination list data, addresses of PCs 502 providing the print data management service are displayed in the descending order of date and time of log-in.

The program further includes: a step S707 of waiting until any one of the displayed addresses is selected by an input operation from the touch-panel formed superposed on display output portion 1304; and a step S708, executed if it is determined at step S707 that any of the displayed addresses is selected, of requesting the PC 502 corresponding to the selected address, to provide the print data management service.

The program further includes a step S709 of waiting until the print data management service is provided from PC 502 to which the request was made.

The program further includes a step S710, executed if it is determined at step S704 that the corresponding service ID is not included (NO), of displaying, on operation panel 1302 of MFP 501, a message that the print data saving destination cannot be displayed. If it is determined at step S709 that the print data management service is provided (YES), or after the process of step S710, the control ends.

<Operation>

Referring to FIG. 16, the second modification of client server system 500 operates in the following manner in the print data saving destination display process. The operation of the second modification of client server system 500 is the same as the operation of client server system 500 in accordance with the second embodiment described above, except for the operation described below.

(Operation in Print Data Saving Destination Display Process)

The user logs in to PCs 502A to 502C, and by an input operation through the operation unit, logs in to the print data management service as one of the services provided by PCs 502A to 502C. When the user logs in to the print data management service, the N-th piece of log-in history information 202 including the user ID read by the IC card reader of PCs 502A to 502C, the service ID indicating the print data management service, a piece of information indicating the date and time of log-in, and a piece of information indicating the date and time of last access is additionally stored in log-in history data 200, and the piece of information 201 is overwritten such that the total number of pieces of log-in history information indicates N. Here, the piece of information indicating the date and time of log-in and the piece of information indicating the date and time of last access indicate the same time. Thereafter, until the user logs out of the print data management service, the piece of information indicating the date and time of last access is rewritten every time the user accesses the print data management service by an input operation through the operation unit.

The user logs in to MFP 501, and issues an instruction requesting display of print data saving destination, using operation panel 1302 of MFP 501.

When the instruction requesting display of print data saving destination is issued (YES at step S701), the control unit of MFP 501 requests PCs 502A to 502C to transmit the service list data including the service ID that is logged in with the user ID read at the time of user authentication by MFP 501 and the corresponding piece of information indicating the date and time of log-in (step S702).

Receiving the request from MFP 501, the control unit of PCs 502A to 502C searches in the log-in history data 200 stored in the HDD, and finds and extracts log-in history information 202 including the user ID read from the IC card at the time of user authentication in MFP 501 and not including a piece of information indicating the date and time of log-out. Then, a service list data is formed, in which the service ID included in the extracted log-in history information 202 and the corresponding piece of information indicating the date and time of log-in are shown in relation to each other. The formed service list data is transmitted to MFP 501.

When the service list data are received from PCs 502A to 502C (YES at step S703), the control unit of MFP 501 determines whether or not the received service list data include a service ID that corresponds to the print data management service provided by PCs 502A to 502C (step S704). Determining that the corresponding service ID is included (YES at step S704), the control unit of MFP 501 extracts only the service IDs corresponding to the print data management services provided by PCs 502A to 502C from the service list data, and sorts the same in the descending order of the date and time of log-in, thereby to form the print data saving destination list data (step S705). An image based on the print data saving destination list data is displayed on operation panel 1302 of MFP 501 (step S706).

The user confirms the displayed image, and by an input operation through the touch-panel formed superposed on display output portion 1304, selects any one of displayed addresses 1306A to 1306C, and thereby selects any one of PCs 502A to 502C as the desired print data saving destination.

When an address is selected by the user (YES at step S707), the control unit of MFP 501 requests any of PCs 502A to 502C that corresponds to the selected address, to provide the print data management service (step S708).

In response to the request for the provision of print data management service, the corresponding one of PCs 502A to 502C provides the print data management service to MFP 501. Thus, it becomes possible to use the print data management service from MFP 501 (YES at step S709).

The control unit of MFP 501 obtains print data list data saved in the HDD 512 of the selected one of PCs 502A to 502C. An image based on the obtained print data list data is displayed on operation panel 1302 of MFP 501. The user confirms the displayed image, and by an input operation through operation panel 1302 of MFP 501, selects the desired print data.

After selection of the print data, MFP 501 obtains the selected print data from any of PCs 502A to 502C. The image forming unit of MFP 501 prints an image based on the obtained print data.

When printing of the print data ends, the user logs out of the print data management service by an input operation through the operation unit of PCs 502A to 502C. After log-out, the information indicating the date and time of log-out is written to the N-th log-in history information 202.

If it is determined that the corresponding service ID is not included (NO at step S704), a message that the print data saving destination cannot be displayed is displayed on operation panel 1302 of MFP 501 (step S710).

### Other Modifications

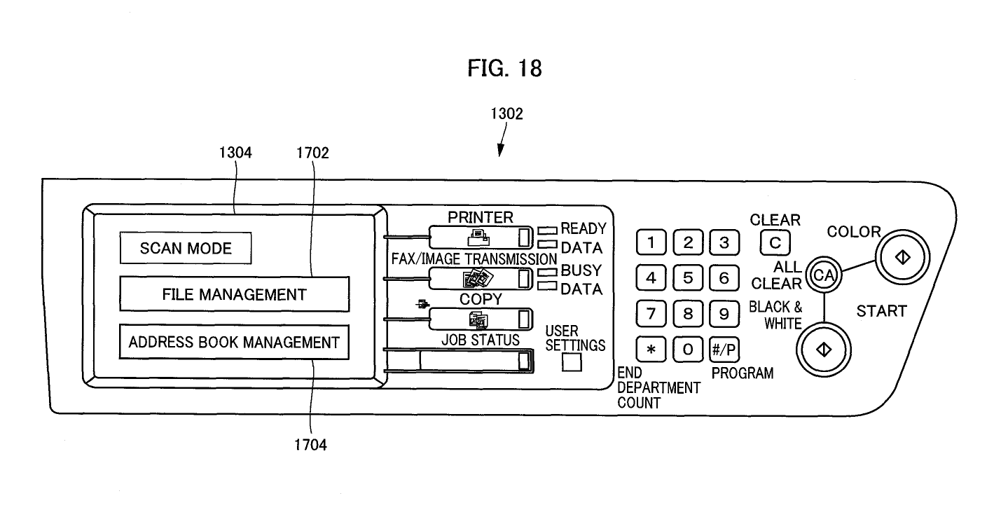

In the second embodiment and the first and second modifications thereof, the scan transmission destination display process, the address book saving destination display process and the print data saving destination display process are executed by MFP 501. The present invention, however, is not limited to such an embodiment. Referring to FIG. 17, in another modification 600 of client server system 500, the processes described above are executed by a dedicated PC 650. In this manner, MFP 601 and dedicated PC 650 operate in a coordinated manner and substantially function as MFP 501, whereby load on the control unit of MFP 601 can be alleviated, and the time necessary for various processes can be reduced. The configuration in which the service list display process is executed by a dedicated PC, MFP 30 and the dedicated PC operate in a coordinated manner and substantially function as MFP 30 may be adopted also in the first embodiment and the modifications thereof.

In the second embodiment and the first and second modifications thereof, MFP 501 can execute any one of the scan transmission destination display process, the address book saving destination display process and the print data saving destination display process. The present invention, however, is not limited to such an embodiment. By way of example, MFP 501 may be configured to enable execution of all the processes described above. In that case, each of the processes may preferably be selected and executed in accordance with the operation mode of MFP 501.

For instance, if the operation mode of MFP 501 is the scan mode, a configuration is preferred in which either one of the scan transmission destination display process and the address book saving destination display process is selected and executed. In that case, when the scan mode is selected by an input operation by the user using operation panel 1302 of MFP 501, a selection image allowing selection of either one of the file management service and the address book management service is displayed on operation panel 1302 of MFP 501.

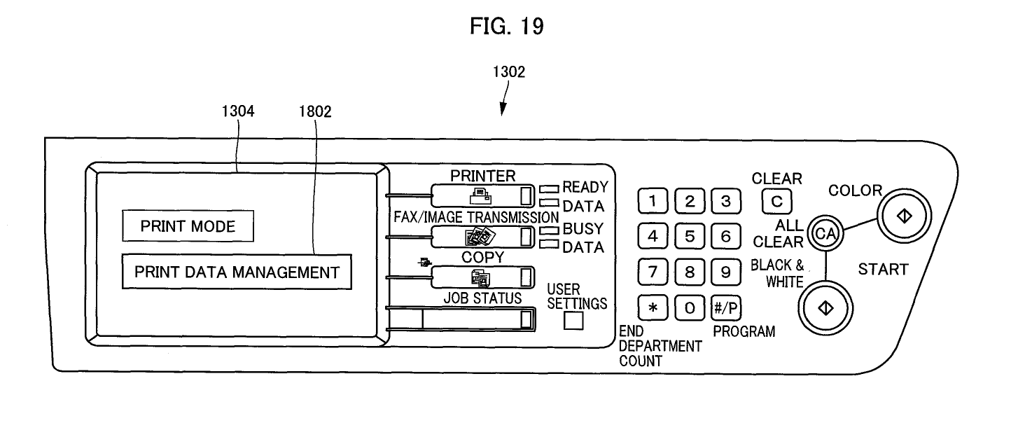

Referring to FIG. 18, on display output portion 1304 of operation panel 1302 of MFP 501, a selection button 1702 for selecting the file management service and a selection button 1704 for selecting the address book management service are displayed as the selection image. When the user presses selection button 1702 by an input operation of the touch-panel formed superposed on display output portion 1304, he/she can make an instruction requesting display of transmission destination of scan image data (see step S501 of FIG. 13). Further, when the user presses selection button 1704, he/she can make an instruction requesting display of the address book saving destination (see step S601 of FIG. 15).

If the operation mode of MFP 501 is the printer mode, a configuration is preferred in which the print data saving destination display process is selected and executed. In that case, when the printer mode is selected by an input operation by the user using operation panel 1302 of MFP 501, a selection image allowing selection of print data management service is displayed on operation panel 1302 of MFP 501.

Referring to FIG. 19, on display output portion 1304 of operation panel 1302 of MFP 501, a selection button 1802 for selecting the print data management service is displayed as the selection image. When the user presses selection button 1802 by an input operation of the touch-panel formed superposed on display output portion 1304, he/she can make an instruction requesting display of print data saving destination (see step S701 of FIG. 16).

Since the service to be executed is selected in accordance with the operation mode of MFP 501, it becomes easier for the user to select the service to be used.

In the second modification of the second embodiment described above, the print data list data shows all print data stored in HDD 512. The present invention, however, is not limited to such an embodiment. By way of example, if the print data is obtained by the direct print function of MFP 501, the print data list data may be adapted to show only the PDF type print data.

<Functions/Effects>

According to the first embodiment and modifications thereof described above, client server system 10 is a system including server apparatuses 20 and 22 providing at least one service, and MFP 30 performing data communication with server apparatuses 20 and 22 through network 11. Each of server apparatuses 20 and 22 includes: HDD 112 storing a service ID indicating a service and a user ID indicating a user who is logged in to the service, in association with each other; control unit 100 searching for a service or services to which the user who is logged in to MFP 30 is logged in based on the information stored in HDD 112, in response to an inquiry from MFP 30; and LAN I/F 118 transmitting the result of search by control unit 100 to MFP 30. MFP 30 includes: operation panel 308; an inquiry function realized by control unit 300, of inquiring the service or services logged in by the user who is logged in to MFP 30; LAN I/F 310 receiving the result of search; and a display control function realized by control unit 300 of displaying an image indicating the service or services logged in by the user who is logged in to MFP 30, on operation panel 308, based on the received result of search.

As described above, of at least one service provided by server apparatuses 20 and 22, an image indicating a service or services logged in by the user who is logged in to MFP 30 is displayed. Therefore, it is possible for the user to easily select a desired service. Further, since the service ID and the user ID are stored automatically, the time and labor for preparing these pieces of information can be saved. Thus, convenience for the user can further be improved.

According to the first embodiment, HDD 112 stores the information of date and time of log-in, indicating the time when the service is logged in, in addition to the service ID and the user ID, and LAN I/F 118 transmits the result of search and the information of date and time of log-in to MFP 30. The display control function of control unit 300 displays, on operation panel 308, an image showing the service or services logged in by the user who is logged in to MFP 30, sorted in the descending order of the date and time of log-in, based on the received search result and the information of date and time of log-in.

As a result, it is possible for the user to confirm at a glance the order of log-in of the displayed service or services, and, for instance, to easily select a service that the user logged in recently. Therefore, it is possible for the user to more easily select a desired service, which is more convenient for the user.

According to the first modification of the first embodiment described above, HDD 112 stores the information of date and time of last access among the accesses made to the service or services to which the user logged in, indicating the time when the service is last accessed, in addition to the service ID and the user ID, and LAN I/F 118 transmits the result of search and the information of date and time of last access to MFP 30. The display control function of control unit 300 displays, on operation panel 308, an image showing the service or services logged in by the user who is logged in to MFP 30, sorted in the descending order of the date and time of last access, based on the received search result and the information of date and time of last access.

As a result, it is possible for the user to confirm at a glance the order of last access to the displayed service or services, and, for instance, to easily select a service that the user used recently. Therefore, it is possible for the user to more easily select a desired service, which is more convenient for the user.

According to the second modification of the first embodiment described above, HDD 112 stores the information of the number of times of log-in indicating how many times the user logged in, in addition to the service ID and the user ID, and LAN I/F 118 transmits the result of search and the information of the number of log-in to MFP 30. The display control function of control unit 300 displays, on operation panel 308, an image showing the service or services logged in by the user who is logged in to MFP 30, sorted in the descending order of the number of times of log-in, based on the received search result and the information of the number of log-in.

As a result, it is possible for the user to confirm at a glance whether the number of times of log-in to a displayed service is large or small. By way of example, the user can easily select a service that is most frequently used. Therefore, it is possible for the user to more easily select a desired service, which is more convenient for the user.

According to the third modification of the first embodiment described above, in MFP 30, HDD 301 stores the usable service management table for limiting services usable from MFP 30, and the display control function of control unit 300 displays, based on the received search result and the usable service management table, on operation panel 308, an image showing the service or services logged in by the user who is logged in to MFP 30 and limited by the usable service management table. As a result, only the service or services logged in by the user who is logged in to MFP 30 and usable from MFP 30 are displayed, which is more convenient for the user.

Preferably, HDD 301 stores, as the usable service management table, the user ID indicating the user, the service or services usable by the user, and a server apparatus or apparatuses usable by the user, in association with each other. By such an approach, use of apparatus and service can be limited on user by user basis and, therefore, the service usable from MFP 30 can more easily be limited.

According to the second embodiment and modifications thereof, client server system 500 is a system including PCs 502A to 502C providing at least one service, and MFP 501 performing data communication with PCs 502A to 502C through network 503. PCs 502A to 502C include HDDs 512 A to 512C storing a service ID indicating a service and a user ID indicating a user who is logged in to the service, in association with each other; control units searching for a service or services to which the user who is logged in to MFP 501 is logged in based on the information stored in HDDs 512A to 512C, in response to an inquiry from MFP 501; and LAN I/Fs transmitting the result of search by the control units to MFP 501. MFP 501 includes: an operation panel 1302; an inquiry function realized by a control unit inquiring a service which is logged in by the user who is logged in to MFP 501; an LAN I/F receiving the result of search; and a display control function of the control unit displaying an image indicating the service logged in by the user who is logged in to MFP 501, on operation panel 1302, based on the received search result.

As described above, an image indicating the service or services logged in by the user who is logged in to MFP 501 among the at least one service provided by PCs 502A to 502C is displayed, it is possible for the user to select the desired service in a simple manner. Further, since the service ID and the user ID are stored automatically, it is possible to save the time and labor of preparing these pieces of information. Thus, convenience for the user can further be improved.

Further, according to the second embodiment and the modifications thereof, in MFP 501, operation panel 1302 allows the user to select a service (file management service, address book management service, or print data management service), and the display control function of the control unit displays an image indicating the service selected by operation panel 1302 among the service or services logged in by the user who is logged in to MFP 501, based on the received result of search, on operation panel 1302. Therefore, an image indicating the service selected by the user among the service or services logged in by the user who is logged in to MFP 501 is displayed, which is more convenient for the user.

Further, according to the second embodiment and the modification thereof, in MFP 501, operation panel 1302 allows the user to select any of a plurality of operation modes, and allows the user to select any of the services in accordance with the selected operation mode. The user can select a service in accordance with the operation mode, and convenience for the user can further be improved.

In the second embodiment and the modifications thereof, the service list data includes the service ID and the piece of information indicating the corresponding date and time of log-in. The present invention, however, is not limited to such an embodiment. By way of example, as in the first and second modifications of the first embodiment, the date and time of last access, or the number of times of log-in may be included, in place of the date and time of log-in.

In the embodiments and modifications thereof described above, in MFPs 30 and 501, operation panels 308 and 1302 receive a service determined as the service to be used by the user who confirmed the displayed image from the services shown on the image, and the control units of MFPs 30 and 501 use the received service. Therefore, the user can easily use the desired service. Thus, convenience for the user can further be improved.

Further, in the embodiments and modifications thereof described above, PC 40 and PCs 502A to 502C further include the IC card reader and the control unit for determining whether or not the user is an authorized user, and permitting log-in of the user to a service if the user is an authorized user. MFPs 30 and 501 further include the IC card reader and the control unit for determining whether or not the user is an authorized user, and permitting log-in of the user to MFPs 30 and 501, if the user is an authorized user.

As described above, since the IC card readers and the control units are provided, it is possible to prevent a third party not permitted to use at least the service or either of MFPs 30 and 501 from abusing the service.

In the embodiments and modifications described above, user authentication is done using an IC card storing the user ID. The present invention, however, is not limited to such an embodiment. By way of example, biometric authentication using, for example, a fingerprint may be adopted. Alternatively, the user ID and a password may be input by an operation of operation panel 308 or operation unit 414.

Further, in the embodiments above, a PC server is used as a server apparatus providing services, and MFPs 30 and 501 are used as client apparatuses that use the services. The present invention, however, is not limited to such embodiments. By way of example, an MFP may be used as the server apparatus, and a PC may be used as a client apparatus. Such an approach may further improve convenience of the MFP and PC.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A client server system, including a server apparatus providing at least one service, and a client apparatus performing data communication with said server apparatus through a network, wherein
said server apparatus includes
a storage unit storing service information indicating said service and user information indicating a user who is logged in to said service, in association with each other,
a searching unit, searching for a service to which a user using the client apparatus is logged in, in response to an inquiry from said client apparatus, based on the information stored in the storage unit, and
a transmitting unit, transmitting the result of search by said searching unit to said client apparatus; and
said client apparatus includes
a display device,
an inquiry unit inquiring of the server apparatus about a service to which the user using said client apparatus is logged in,
a receiving unit receiving the result of search, and
a display control unit causing said display device to display an image indicating the service to which the user using said client apparatus is logged in, based on said received result of search.

2. The client server system according to claim 1, wherein
said storage unit stores log-in date and time information indicating the time of log-in to said service, in association with said service information and said user information;
said transmitting unit transmits said result of search and said log-in date and time information to said client apparatus; and
said display control unit causes said display device to display an image showing services logged in by the user who is using said client apparatus sorted in the order of date and time of log-in, based on said received result of search and said log-in date and time information.

3. The client server system according to claim 1, wherein
said storage unit stores last access date and time information indicating the time when last access was done among accesses to said service while said user was logged in, in association with said service information and said user information;
said transmitting unit transmits said result of search and said last access date and time information to said client apparatus; and
said display control unit causes said display device to display an image showing services logged in by the user who is using said client apparatus sorted in the order of date and time of last access, based on said received result of search and said last access date and time information.

4. The client server system according to claim 1, wherein
said storage unit stores log-in number information indicating the number of times of log-in by said user, in association with said service information and said user information;
said transmitting unit transmits said result of search and said log-in number information to said client apparatus; and
said display control unit causes said display device to display an image showing services logged in by the user who is using said client apparatus sorted in the order of the number of times of log-in, based on said received result of search and said log-in number information.

5. The client server system according to claim 1, wherein
said client apparatus further includes a limiting information storage unit storing limiting information for limiting a service or services usable by said client apparatus; and
said display control unit causes said display device to display an image showing the service or services limited by said limiting information, among services logged in by the user who is using said client apparatus, based on said received result of search and said limiting information.

6. The client server system according to claim 5, wherein said limiting information storage unit stores, as said limiting information, user information indicating a user, a service or services usable by said user, and said server apparatus or server apparatuses usable by said user, in association with each other.

7. The client server system according to claim 1, wherein
said client apparatus further includes a service selecting unit allowing said user to select any of said services; and
said display control unit causes said display device to display an image showing the service selected by said service selecting unit, among services logged in by the user who is using said client apparatus, based on said received result of search.

8. The client server system according to claim 7, wherein
said client apparatus further includes a mode selecting unit allowing said user to select any of a plurality of operation modes; and
said service selecting unit allows said user to select any of services in accordance with the operation mode selected by said mode selecting unit.

9. The client server system according to claim 1, wherein
said client apparatus further includes
a receiving unit receiving a service determined by said user as a service to be used, from the services indicated by said image, and
a using unit using the service received by said receiving unit.

10. The client server system according to claim 1, wherein
said server apparatus further includes
a first authentication unit determining whether or not a user is an authorized user, and permitting log-in by said user to said service if the user is an authorized user; and
said client apparatus further includes
a second authentication unit determining whether or not a user is an authorized user, and permitting log-in by said user to said client apparatus if the user is an authorized user.

11. The client server system according to claim 1, wherein said server apparatus is a personal computer, and said client apparatus is an image forming apparatus.

12. The client server system according to claim 1, wherein said server apparatus is an image forming apparatus and said client apparatus is a personal computer.

13. A client apparatus performing data communication through a network with a server apparatus providing at least one service, comprising:
a display apparatus;
an inquiry unit inquiring of the server apparatus about a service to which the user using said client apparatus is logged in,
a receiving unit receiving result of search obtained from said server apparatus by a search for the service to which the user using said client apparatus is logged in, based on information storing service information indicating said service and user information indicating a user logged in to said service in association with each other, in response to said inquiry; and
a display control unit causing said display device to display an image indicating the service to which the user using said client apparatus is logged in, based on said received result of search.

14. A server apparatus providing at least one service and performing data communication through a network with a client apparatus, comprising:
a storage unit storing service information indicating said service and user information indicating a user who is logged in to said service, in association with each other,
a searching unit, searching for a service to which a user using the client apparatus is logged in, in response to an inquiry from said client apparatus, based on the information stored in the storage unit, and
a transmitting unit, transmitting the result of search by said searching unit to said client apparatus.
